(19) United States
(12) Patent Application Publication
(10) Pub. No.: US 2014/0092301 A1
(43) Pub. Date: Apr. 3, 2014

(54) DATA STRUCTURE, IMAGE TRANSMITTING APPARATUS, IMAGE RECEIVING APPARATUS, DISPLAY APPARATUS, IMAGE TRANSMITTING METHOD, AND RECORDING MEDIUM

(71) Applicant: Takeshi Kumakura, Osaka-shi (JP)

(72) Inventor: Takeshi Kumakura, Osaka-shi (JP)

(73) Assignee: SHARP KABUSHIKI KAISHA, Osaka-shi, Osaka (JP)

(21) Appl. No.: 14/119,206

(22) PCT Filed: May 22, 2012
(86) PCT No.: PCT/JP2012/063040

§ 371 Date: Nov. 21, 2013

(30) Foreign Application Priority Data
May 25, 2011 (JP) 2011-117387

(51) Int. Cl. H04N 7/01

(52) U.S. Cl. CPC H04N 7/0125
USPC 348/441

(57) ABSTRACT

The present data structure includes content data indicating content of an original image and identification data indicating whether a transmission format is a first or second format, the first format being a format that divides the original image into n areas (n is an integer greater than or equal to 2) and transmits the n area images on first to n-th channels, and the second format being a format that divides the original image into n images (n is an integer greater than or equal to 2) with definition lower than the original image and transmits the n images on first to n-th channels. Accordingly, realization of an image receiving apparatus that can handle the single scan format and the block scan format is facilitated.

### TECHNICAL FIELD

The present invention relates to image technology.

### BACKGROUND ART

The number of pixels of current high definition television broadcasting (so-called full HD (FHD) is horizontal 1920×vertical 1080 (so-called 2K1K). Image standards (super high vision SHV is one of them) with the number of pixels four times greater than the full HD (so-called 4K2K) or the number of pixels sixteen times greater than the full HD (so-called ultra high definition or 8K4K) have been proposed.

For example, as an ultra high definition image transmission format, a format that divides an original ultra-high-definition image (frame) into high-definition images in n areas (n is plural) and transmits the images on n channels (single-scan multi-display transmission format, hereinafter simply referred to as a single scan format) and a format that divides an original ultra-high-definition image into n images (n is plural) with definition lower than the original image (so-called skipped images in which pixels are skipped to interpolate one another) and transmits the images on n channels (block-scan single-display transmission format, hereinafter simply referred to as a block scan format) have been proposed (for example, see PTL 1).

### CITATION LIST

### Patent Literature

PTL 1: Japanese Unexamined Patent Application Publication No. 2009-130639

### SUMMARY OF INVENTION

### Technical Problem

As described above, the method of dividing (transmitting) an image is different in the block scan format and the single scan format. Thus, there is a problem that an image receiving apparatus that corresponds to the block scan format is incapable of handling an image transmitted in the single scan format, and an image receiving apparatus that corresponds to the single scan format is incapable of handling an image transmitted in the block scan format. There has been a demand for realization of an image receiving apparatus that can handle both formats.

An object of the present invention is to facilitate realization of an image receiving apparatus that can handle both formats.

### Solution to Problem

The present data structure includes content data indicating content of an original image and identification data indicating whether a transmission format is a first or second format, the first format being a format that divides the original image into n areas (n is an integer greater than or equal to 2) and transmits the n area images on first to n-th channels, and the second format being a format that divides the original image into n images (n is an integer greater than or equal to 2) with definition lower than the original image and transmits the n images on first to n-th channels.

Accordingly, realization of an image receiving apparatus that can handle both formats can be facilitated by configuring a data structure including content data and identification data indicating a transmission format.

### Advantageous Effects of Invention

Realization of an image receiving apparatus that can handle the single scan format and the block scan format can be facilitated.

### BRIEF DESCRIPTION OF DRAWINGS

FIG. 1 is a schematic diagram illustrating an exemplary configuration of an image transmitting apparatus and an image receiving apparatus of a first embodiment.

FIG. 2 is a schematic diagram explaining the single scan format and the block scan format.

FIG. 3 is a schematic diagram illustrating pixel mapping in the block scan format in the first embodiment.

FIG. 4 is a schematic diagram illustrating pixel mapping in the single scan format in the first embodiment.

FIG. 5 is a schematic diagram illustrating the position of auxiliary data in image data in HDMI transmission.

FIG. 6 is a schematic diagram illustrating an exemplary configuration in the case where HDMI is used in transmission between the image transmitting apparatus and the image receiving apparatus.

FIG. 7 is a table representing a specific example of auxiliary data (including identification data) in the first embodiment.

FIG. 8 is a schematic diagram illustrating an exemplary configuration of an image transmitting apparatus and an image receiving apparatus of a second embodiment.

FIG. 9 is a schematic diagram illustrating pixel mapping in the block scan format in the second embodiment.

FIG. 10 is a table representing a specific example of auxiliary data (including identification data) in the second embodiment.

FIG. 11 is a schematic diagram illustrating the configuration of a liquid crystal display according to a third embodiment.

### DESCRIPTION OF EMBODIMENTS

### First Embodiment

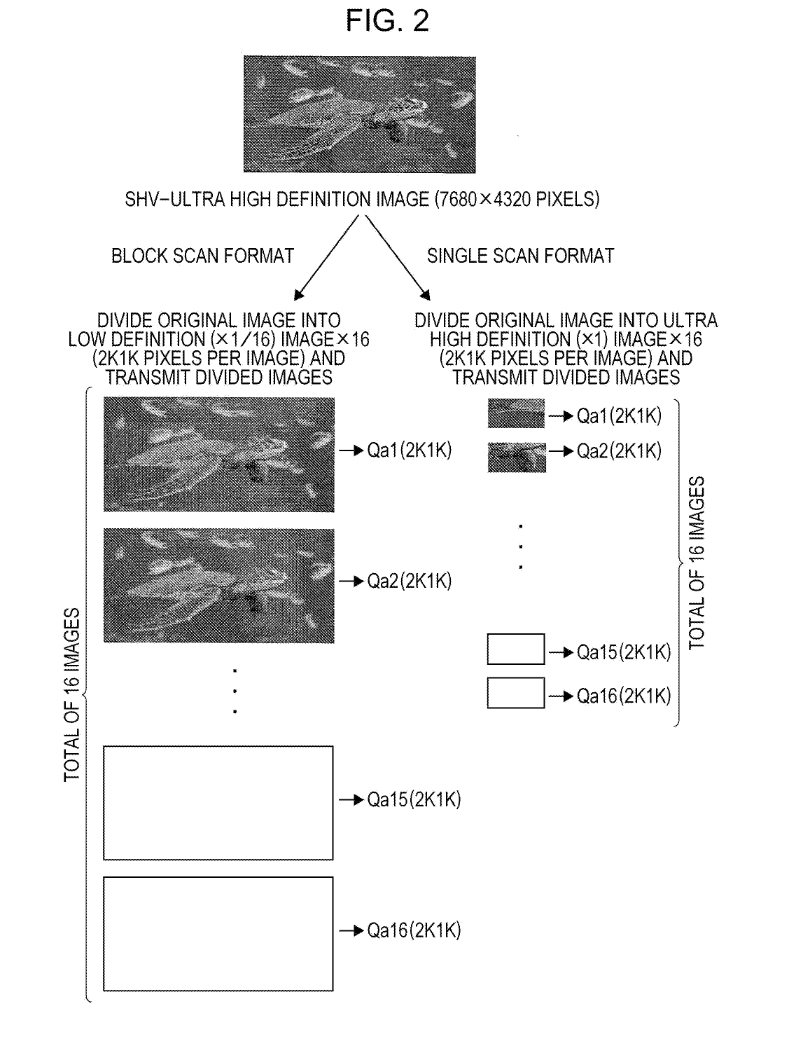

As input (transmission) formats of super high vision image data, there are the single scan format (see FIG. 2) which divides an original image (frame) into images in sixteen areas without changing the definition and transmits the images on sixteen channels, and the block scan format (see FIG. 2) which divides an original image into sixteen images with definition that is one sixteenth of the original image (so-called skipped images in which pixels are skipped to interpolate one another) and transmits the sixteen images on n channels. Note that, in the block scan format, the entire image with the one sixteenth definition (in a state where pixels are skipped) can be viewed even with one channel.

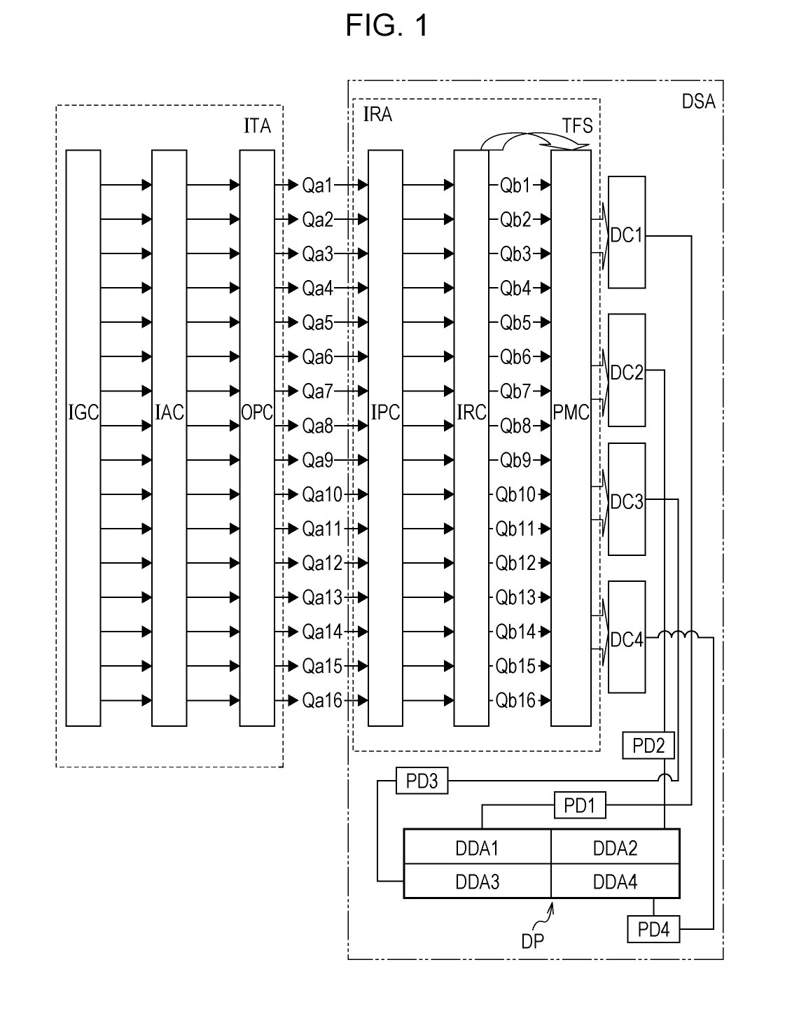

An image transmitting apparatus ITA of a first embodiment includes, as illustrated in FIG. 1, an image data generation circuit IGC that divides the original image into sixteen images and generates image data (including content data) on the first to sixteenth channels, an identification data appending circuit IAC that appends identification data indicating a (dividing) transmission format to at least one channel of the image data on the first to sixteenth channels, and an output processing circuit OPC that transmits each piece of the image data on the first to sixteenth channels via a differential transmission path (such as TMDS). Note that the identification data appending circuit IAC may be configured to append the same identification data to the image data on all the first to sixteenth channels.

In addition, a display apparatus DSA of the first embodiment includes an image receiving apparatus IRA that includes an input processing circuit IPC, an identification data reading circuit IRC, a pixel mapping circuit PMC, a display panel DP that includes four divided display areas DDA1 to DDA4, and panel driving circuits PD1 to PD4 that drive the four divided display areas DDA1 to DDA4, respectively. Note that the display panel DP is, for example, an 8K4K panel (7680×4320 pixels), and the way the display panel DP is divided into four portions includes a format that divides the upper side into left and right two portions and the lower side into left and right two portions (see FIG. 1) and a format that divides the display panel DP into four portions in the left and right direction regardless of the upper or lower side. For the 8K4K panel, there is also a format that divides the upper side into four portions in the left and right direction and the lower side into four portions in the left and right direction (eight dividing format), as will be described later.

Image data Qa1 to Qa16 on the first to sixteenth channels, output from the output processing circuit OPC, are input in parallel with one another (concurrently) to the input processing circuit IPC. The input processing circuit IPC performs γ curve correction, color temperature correction, color space conversion, and the like in order to perform panel display suitable for synchronization processing of data of individual pixels and for an input image standard, and outputs image data (Qb1 to Qb16) to the identification data reading circuit IRC.

The identification data reading circuit IRC reads identification data from the image data on the first to sixteenth channels, recognizes whether these pieces of image data are in the single scan format or the block scan format, and outputs the image data Qb1 to Qb16 and a transmission format signal TFS to the pixel mapping circuit PMC.

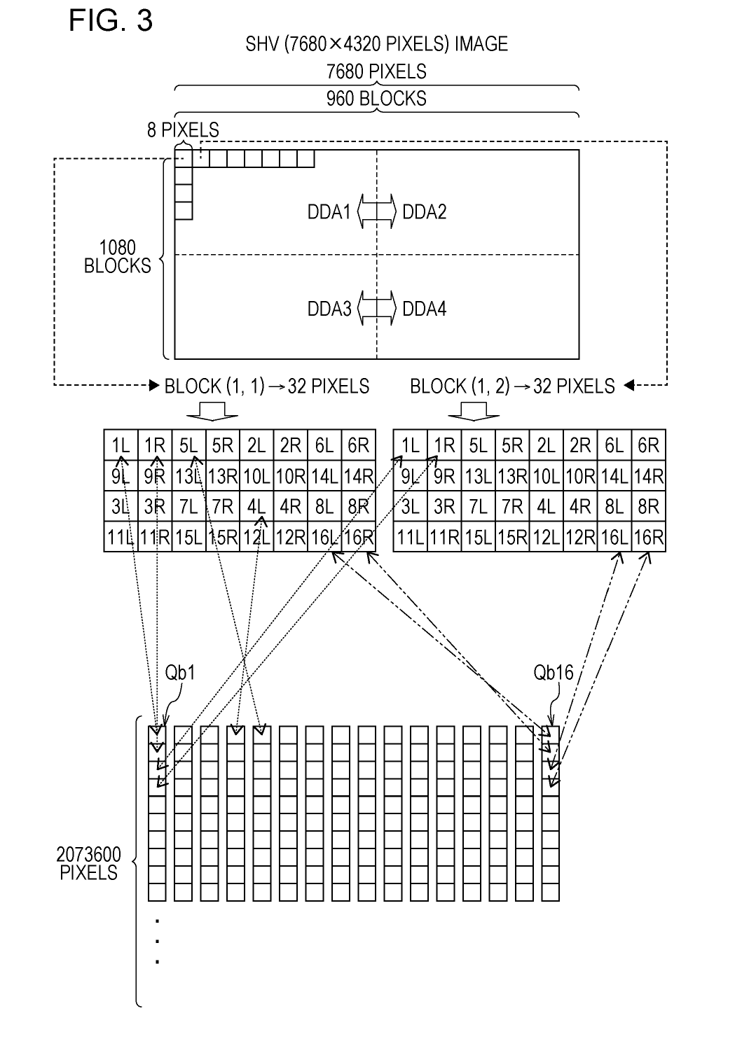

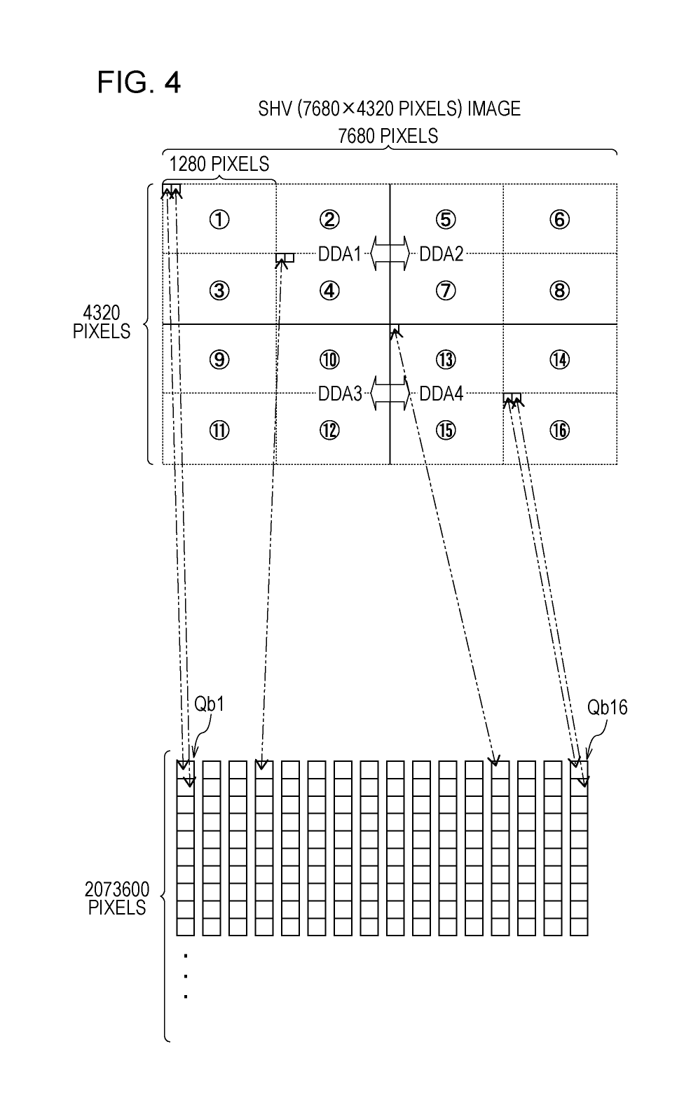

The pixel mapping circuit PMC sorts the image data on the first to sixteenth channels in accordance with the transmission format signal TFS and the panel driving format (quad drive, see FIG. 1) (pixel mapping), and outputs the sorted data to the display control substrates DC1 to DC4. The display control substrates DC1 to DC4 control the panel driving circuits PD1 to PD4, respectively. Specifically, in the block scan format, for example, pixel mapping as illustrated in FIG. 3 is performed; and, in the single scan format, for example, pixel mapping as illustrated in FIG. 4 is performed.

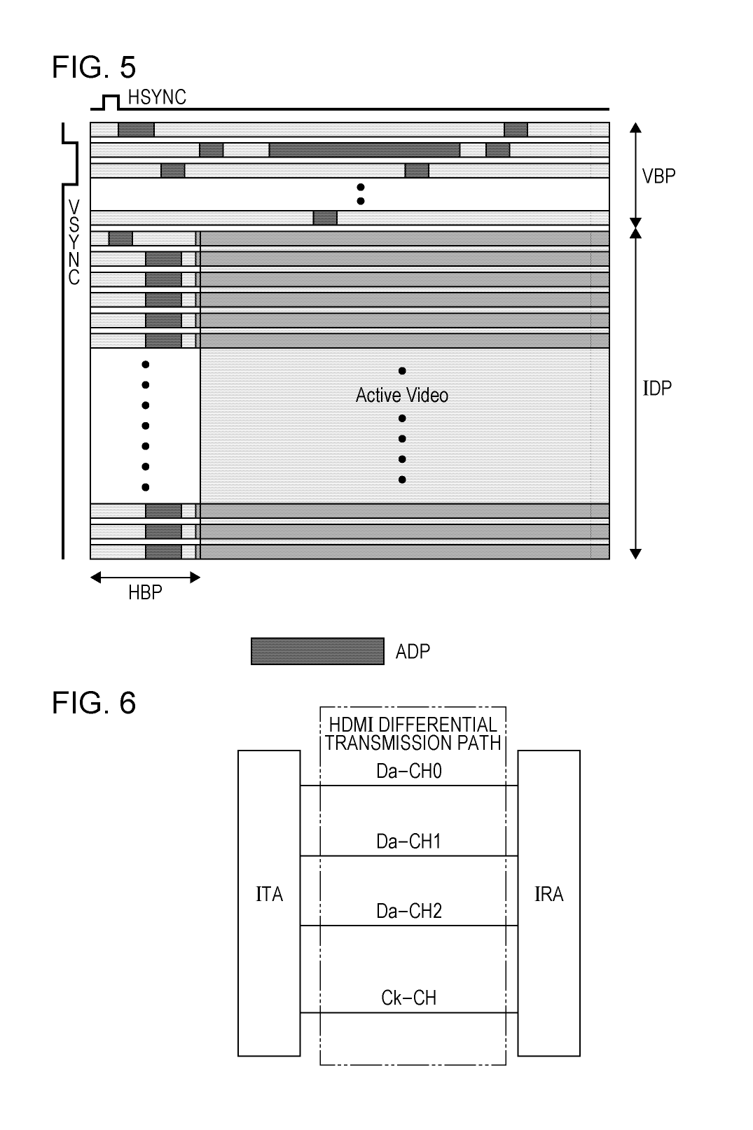

FIG. 5 is a schematic diagram illustrating an image data input condition (corresponding to one channel) in the case where HDMI (High Definition Multimedia Interface) is used for input to each channel of the first to sixteenth channels. As illustrated in FIG. 5, an auxiliary data period ADP is provided in blanking periods (a vertical blanking period VBP and a horizontal blanking period HBP) other than an image display period IDP, and auxiliary data such as audio data, frame resolution, and the number of colors is transmitted in this auxiliary data period ADP. Since a free area (area where specific auxiliary data is not allocated, a reserve area) is provided in the auxiliary data period ADP, for example, identification data (flag) is only necessary to be appended in this free area (see Japanese Unexamined Patent Application Publication No. 2006-352599 and Japanese Unexamined Patent Application Publication No. 2005-184441).

An HDMI transmission path (corresponding to one channel) between the image transmitting apparatus ITA and the image receiving apparatus IRA includes, as illustrated in FIG. 6, three data channels (Da-CH0, Da-CH1, and Da-CH2) and a clock channel (CK-CH). Auxiliary data is arranged into packets and transmitted via the three data channels, and the content thereof is specified in a Type value (address) of the packet header.

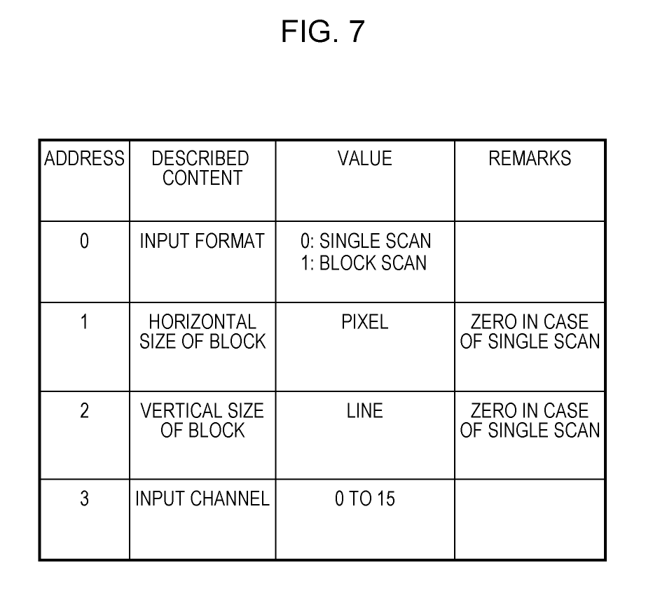

FIG. 7 is an example of auxiliary data included in image data of the first embodiment. The address indicates a byte address in the auxiliary data. Firstly, identification data indicating the transmission format (the single scan format or the block scan format) is included as one piece of the auxiliary data. In the case of the block scan format (in the case where the value of auxiliary data at address 0 is 1), auxiliary data indicating the horizontal size (such as eight pixels) of one block, auxiliary data indicating the vertical size (such as four lines) of one block, and auxiliary data indicating the input channel (0 to 15) are further included.

In the single scan format, the horizontal size and the vertical size of one block are inapplicable; thus, they are set to 0. The auxiliary data of the input channel is optional and indicates the position of pixel data to be transmitted on each channel. By adding this auxiliary data of the input channel, the pixel mapping circuit PMC can bring a pixel to the correct position even in the case where the input channel is incorrect (that is, even in the case where sixteen cables are incorrectly inserted). Needless to say, this is unnecessary in the case where the pixel position corresponding to each cable is determined (see Japanese Unexamined Patent Application Publication No. 2005-184441).

As described above, according to the present embodiment, realization of a display that can handle multiple input formats for transmitting an ultra high definition image can be facilitated. That is, the circuit of an input unit of a display can be made common in both input formats, and the circuit dimensions and cost can be reduced.

In addition, only one input format is necessary to be saved at an image recorder side, and the recording capacity of an HDD (hard disk) or the like can be saved. Also, there is an advantage that the user is not required to perform system setting while paying attention to the input format.

### Second Embodiment

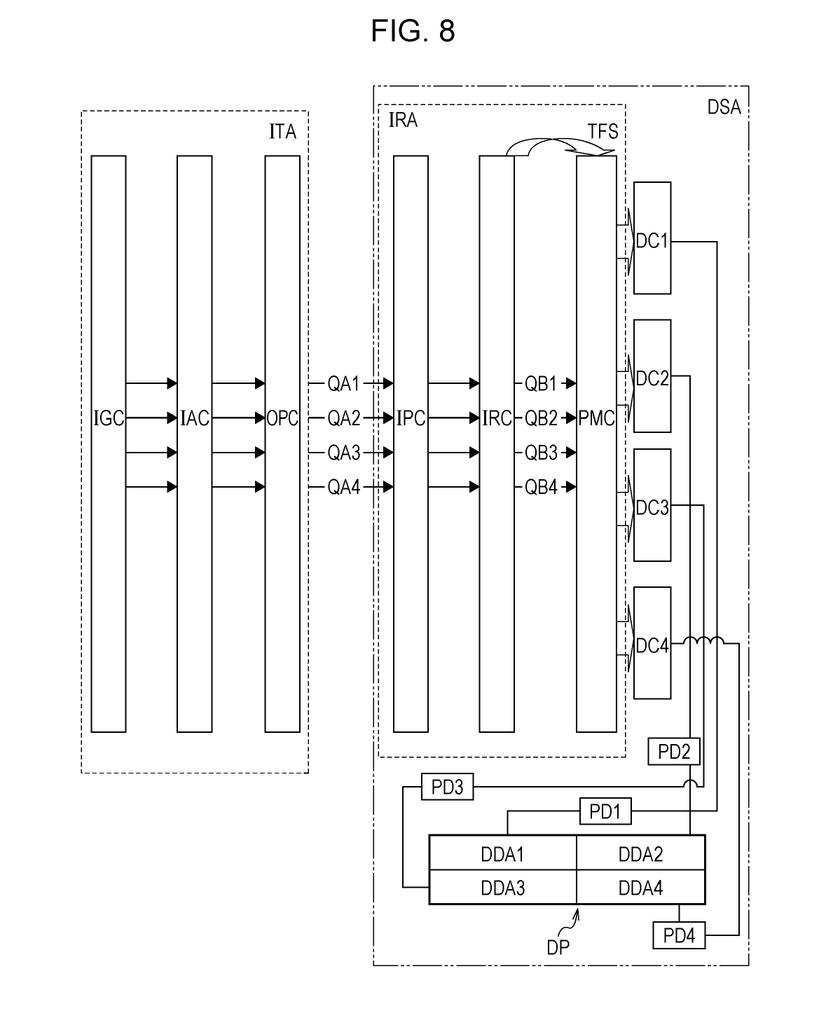

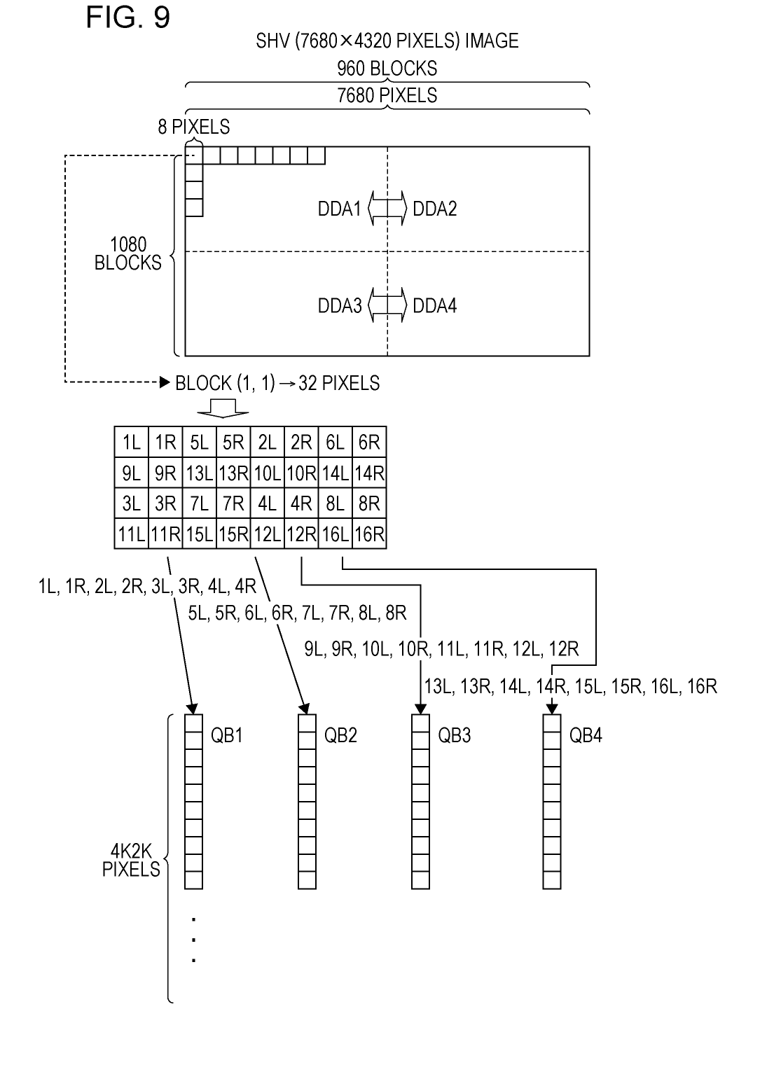

Although the original image is divided into sixteen images and the sixteen images are transmitted on the first to sixteenth channels in the first embodiment, the image division and transmission is not limited thereto. For example, as illustrated in FIG. 8, the image transmitting apparatus ITA may divide the original image into four images and transmit the four images on the first to fourth channels (image data QA1 to QA4). In this case, if the original image is an 8K4K-size image, 4K2K pixels are transmitted per channel. In the case where the transmission format signal TFS indicates the block scan format, the pixel mapping circuit PMC performs pixel mapping as illustrated in FIG. 9.

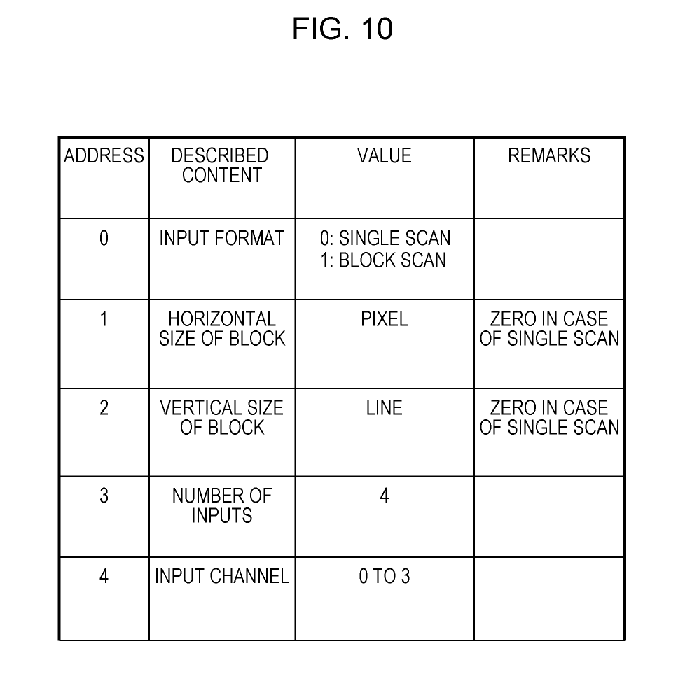

FIG. 10 is an example of auxiliary data included in image data of the second embodiment. As illustrated in FIG. 10, not only auxiliary data indicating the input channel (0 to 3), but also auxiliary data indicating the number of inputs (4) may be added.

### Third Embodiment

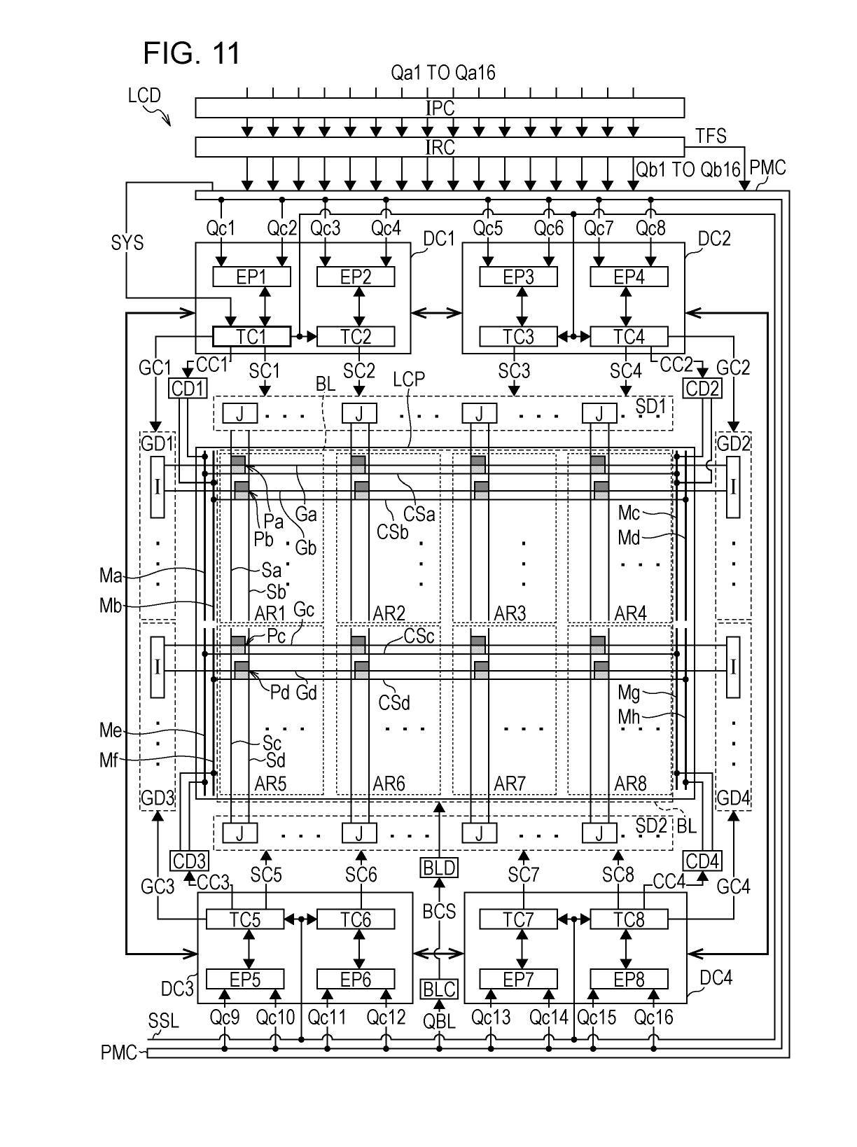

A liquid crystal display LCD according to a third embodiment corresponds to an image standard (such as super high vision with horizontal 7680 pixels×vertical 4320 pixels) with the number of pixels (8K4K) sixteen times greater than the number of pixels of full HD (horizontal 1920 pixels×vertical 1080 pixels). As illustrated in FIG. 11, the liquid crystal display LCD includes the input processing circuit IPC, the identification data reading circuit IRC, the pixel mapping circuit PMC, the four display control substrates (timing controller substrates) DC1 to DC4, a liquid crystal panel LCP, four gate drivers GD1 to GD4, two source drivers SD1 and SD2, four CS drivers CD1 to CD4, three power supply devices (not illustrated) connected to different commercial power sources, a power controller (not illustrated), a backlight BL, a backlight driver BLD, and a backlight controller BLC.

Identification data (auxiliary data) enabling recognition of the block scan format or the single scan format is added to the input image signals Qa1 to Qa16. The input processing circuit IPC performs the aforementioned processing of the image signals Qa1 to Qa16 and outputs the image signals Qb1 to Qb16 to the identification data reading circuit IRC.

The identification data reading circuit IRC reads the identification data from the image data on the first to sixteenth channels, recognizes whether the transmission format of the image data is the single scan format or the block scan format, and outputs the transmission format signal TFS to the pixel mapping circuit PMC. The pixel mapping circuit PMC performs pixel mapping in accordance with the transmission format signal TFS.

Here, the display control substrate DC1 includes two image processing circuits EP1 and EP2 and two timing controllers TC1 and TC2; the display control substrate DC2 includes two image processing circuits EP3 and EP4 and two timing controllers TC3 and TC4; the display control substrate DC3 includes two image processing circuits EP5 and EP6 and two timing controllers TC5 and TC6; and the display control substrate DC4 includes two image processing circuits EP7 and EP8 and two timing controllers TC7 and TC8.

The pixel mapping circuit PMC divides an image signal (2K2K pixels) corresponding to the left half AR1 of a local area 1 (the upper left-hand area in the case where the liquid crystal panel LCP is divided into four upper/lower and left/right portions) into two signals (image signals Qc1 and Qc2 with full HD pixels) and outputs the two signals to the image processing circuit EP1 of the display control substrate DC1; divides an image signal (2K2K pixels) corresponding to the right half AR2 of the aforementioned local area 1 into two signals (image signals Qc3 and Qc4 with full HD pixels) and outputs the two signals to the image processing circuit EP2 of the display control substrate DC1; divides an image signal (2K2K pixels) corresponding to the left half AR3 of a local area 2 (the upper right-hand area in the case where the liquid crystal panel LCP is divided into four upper/lower and left/right portions) into two signals (image signals Qc5 and Qc6 with full HD pixels) and outputs the two signals to the image processing circuit EP3 of the display control substrate DC2; divides an image signal (2K2K pixels) corresponding to the right half AR4 of the aforementioned local area 2 into two signals (image signals Qc7 and Qc8 with full HD pixels) and outputs the two signals to the image processing circuit EP4 of the display control substrate DC2; divides an image signal (2K2K pixels) corresponding to the left half AR5 of a local area 3 (the lower left-hand area in the case where the liquid crystal panel LCP is divided into four upper/lower and left/right portions) into two signals (image signals Qc9 and Qc10 with full HD pixels) and outputs the two signals to the image processing circuit EP5 of the display control substrate DC3; divides an image signal (2K2K pixels) corresponding to the right half AR6 of the aforementioned local area 3 into two signals (image signals Qc11 and Qc12 with full HD pixels) and outputs the two signals to the image processing circuit EP6 of the display control substrate DC3; divides an image signal (2K2K pixels) corresponding to the left half AR7 of a local area 4 (the lower right-hand area in the case where the liquid crystal panel LCP is divided into four upper/lower and left/right portions) into two signals (image signals Qc13 and Qc14 with full HD pixels) and outputs the two signals to the image processing circuit EP7 of the display control substrate DC4; and divides an image signal (2K2K pixels) corresponding to the right half AR8 of the aforementioned local area 4 into two signals (image signals Qc15 and Qc16 with full HD pixels) and outputs the two signals to the image processing circuit EP8 of the display control substrate DC4.

Further, the pixel mapping circuit PMC outputs a sync signal SYS (vertical sync signal, horizontal sync signal, clock signal, data enable signal, etc.) to the timing controller TC1 of the display control substrate DC1. Upon receipt of this sync signal SYS, the timing controller TC1 transmits the sync signal SYS to an inter-substrate shared line SSL connected to the display control substrates DC1 to DC4.

Upon receipt of the sync signal SYS from the pixel mapping circuit PMC, the timing controller TC1 cooperates with the image processing circuit EP1 to perform image processing such as grayscale conversion processing of the image signals Qc1 and Qc2, thereafter outputs a source control signal SC1 to a source driver substrate (not illustrated) corresponding to AR1, outputs a gate control signal GC1 to a gate driver substrate (not illustrated) of the gate driver GD1, and outputs a CS control signal CC1 to the CS driver CD1.

Upon receipt of the sync signal SYS transmitted from the timing controller TC1 via the inter-substrate shared line SSL, the timing controller TC2 cooperates with the image processing circuit EP2 to perform the aforementioned processing of the image signals Qc3 and Qc4, and thereafter outputs a source control signal SC2 to a source driver substrate (not illustrated) corresponding to AR2.

Upon receipt of the sync signal SYS transmitted from the timing controller TC1 via the inter-substrate shared line SSL, the timing controller TC3 cooperates with the image processing circuit EP3 to perform the aforementioned processing of the image signals Qc5 and Qc6, and thereafter outputs a source control signal SC3 to a source driver substrate (not illustrated) corresponding to AR3.

Upon receipt of the sync signal SYS transmitted from the timing controller TC1 via the inter-substrate shared line SSL, the timing controller TC4 cooperates with the image processing circuit EP4 to perform the aforementioned processing of the image signals Qc7 and Qc8, thereafter outputs a source control signal SC4 to a source driver substrate (not illustrated) corresponding to AR4, outputs a gate control signal GC2 to a gate driver substrate (not illustrated) of the gate driver GD2, and outputs a CS control circuit CC2 to the CS driver CD2.

Upon receipt of the sync signal SYS transmitted from the timing controller TC1 via the inter-substrate shared line SSL, the timing controller TC5 cooperates with the image processing circuit EP5 to perform the aforementioned processing of the image signals Qc9 and Qc10, thereafter outputs a source control signal SC5 to a source driver substrate (not illustrated) corresponding to AR5, outputs a gate control signal GC3 to a gate driver substrate (not illustrated) of the gate driver GD3, and outputs a CS control circuit CC3 to the CS driver CD3.

Upon receipt of the sync signal SYS transmitted from the timing controller TC1 via the inter-substrate shared line SSL, the timing controller TC6 cooperates with the image processing circuit EP6 to perform the aforementioned processing of the image signals Qc11 and Qc12, and thereafter outputs a source control signal SC6 to a source driver substrate (not illustrated) corresponding to AR6.

Upon receipt of the sync signal SYS transmitted from the timing controller TC1 via the inter-substrate shared line SSL, the timing controller TC7 cooperates with the image processing circuit EP7 to perform the aforementioned processing of the image signals Qc13 and Qc14, and thereafter outputs a source control signal SC7 to a source driver substrate (not illustrated) corresponding to AR7.

Upon receipt of the sync signal SYS transmitted from the timing controller TC1 via the inter-substrate shared line SSL, the timing controller TC8 cooperates with the image processing circuit EP8 to perform the aforementioned processing of the image signals Qc15 and Qc16, thereafter outputs a source control signal SC8 to a source driver substrate (not illustrated) corresponding to AR8, outputs a gate control signal GC4 to a gate driver substrate (not illustrated) of the gate driver GD4, and outputs a CS control circuit CC4 to the CS driver CD4.

Note that the source control signals SC1 to SC8 each include a data signal, a data latch signal, a source start pulse, and a source clock, and the gate control signals GC1 to GC4 each include a gate start pulse and a gate clock.

The display control substrates DC1 to DC4 enable synchronization of their operations by exchanging or sharing various signals among the display control substrates DC1 to DC4. Specifically, the display control substrate DC1, acting as a master, sends a RDY (preparation is complete) signal to the display control substrate DC2, which is a slave. Upon receipt of the RDY signal, the display control substrate DC2 sends the RDY signal to the display control substrate DC3, which is a slave, upon completion of preparation. Upon receipt of the RDY signal, the display control substrate DC3 sends the RDY signal to the display control substrate DC4, which is a slave, upon completion of preparation. Upon receipt of the RDY signal, the display control substrate DC4 sends the RDY signal back to the display control substrate DC1 upon completion of preparation. In response to the fact that the RDY signal has been sent back, the display control substrate DC1 transmits an operation start (SRST) signal to the display control substrates DC2 to DC4 at the same time via the inter-substrate shared line SSL. After the operation start (SRST) signal has been transmitted, the timing controller TC1 of the display control substrate DC1 transmits the aforementioned sync signal SYS, received from the pixel mapping circuit PMC, to the timing controllers TC2 to TC8 at the same time via the inter-substrate shared line SSL.

The liquid crystal panel LCP includes an active matrix substrate, a liquid crystal layer (not illustrated), and an opposed substrate (not illustrated). The active matrix substrate is provided with a plurality of pixel electrodes (not illustrated), a plurality of TFTs (thin film transistors, not illustrated), scanning signal lines Ga to Gd extending in the row direction (direction along the long side of the panel), a plurality of data signal lines Sa to Sd extending in the column direction, holding capacitance wires (CS wires) CSa to CSd extending in the row direction, and CS main wires Ma to Mh extending in the column direction. The opposed substrate is provided with a common electrode (not illustrated), color filters, and a black matrix (not illustrated).

In addition, the gate driver GD1 is provided along one of two short sides of the upper half of the liquid crystal panel LCP and includes a plurality of gate driver chips I arranged in the column direction. The vertical driver GD2 is provided along the other one of the two short sides of the upper half of the liquid crystal panel LCP and includes a plurality of gate driver chips I arranged in the column direction. In addition, the gate driver GD3 is provided along one of two short sides of the lower half of the liquid crystal panel LCP and includes a plurality of gate driver chips I arranged in the column direction. The vertical driver GD4 is provided along the other one of the two short sides of the lower half of the liquid crystal panel LCP and includes a plurality of gate driver chips I arranged in the column direction. The individual scanning signal lines provided in the upper half of the panel are driven by the gate drivers GD1 and GD2, and the individual scanning signal lines provided in the lower half of the panel are driven by the gate drivers GD3 and GD4. That is, one scanning signal line is connected to two gate drivers arranged at two sides of the scanning signal line, and scanning (pulse) signals in the same phase are supplied from the two gate drivers to the scanning signal line. In this way, variation of signal shape sharpness (the degree of signal shape sharpness changes depending on the position in the row direction) caused by CR (time constant) of the scanning signal line can be suppressed.

The source driver SD1 is provided along one long side of the upper half of the liquid crystal panel LCP, and includes 48 source driver chips J arranged in the row direction (the number of output terminals of one source driver chip is 960) and not-illustrated four source driver substrates (twelve source driver chips J are mounted on one source driver substrate). Meanwhile, the source driver SD2 is provided along one long side of the lower half of the liquid crystal panel LCP, and includes 48 source driver chips J arranged in the row direction (the number of output terminals of one source driver chip is 960) and not-illustrated four source driver substrates (twelve source driver chips J are mounted on one source driver substrate). The individual data signal lines provided in the upper half of the panel are driven by the source driver SD1, and the individual data signal lines provided in the lower half of the panel are driven by the source driver SD2. For example, a data signal line Sa is driven by the source driver SD1, and a data signal line Sc is driven by the source driver SD2.

The liquid crystal panel LCP has a so-called up-down divided double source structure (the structure with four data signal lines per pixel column, capable of concurrently selecting four scanning signal lines), in which two data signal lines are provided corresponding to the upper half of one pixel column (a first area, the upstream side of the panel) and two data signal lines are provided corresponding to the lower half of the pixel column (a second area, the downstream side of the panel), and is capable of performing quad-speed drive. Further, the liquid crystal panel LCP uses a so-called multi-pixel system that has at least two pixel electrodes per pixel, and viewing angle characteristics can be enhanced by a bright area and a dark area formed inside one pixel.

Note that the number of data signal lines provided in the upper half of the panel is at least 7680 (pixels)×3 (primary colors)×2 (double sources)=46080; the number of scanning signal lines provided in the upper half of the panel is at least 2160; the number of holding capacitance wires provided in the upper half of the panel is at least 2160; the number of data signal lines provided in the lower half of the panel is at least 46080; the number of scanning signal lines provided in the lower half of the panel is at least 2160; and the number of holding capacitance wires provided in the lower half of the panel is at least 2160.

As described above, the present data structure includes content data indicating content of an original image and identification data indicating whether a transmission format is a first or second format, the first format being a format that divides the original image into n areas (n is an integer greater than or equal to 2) and transmits the n area images on first to n-th channels, and the second format being a format that divides the original image into n images (n is an integer greater than or equal to 2) with definition lower than the original image and transmits the n images on first to n-th channels.

As described above, because the data structure includes content data and identification data indicating a transmission format, realization of an image receiving apparatus that can handle both formats can be facilitated.

In the present data structure, the identification data may be configured as one piece of auxiliary data.

In the present data structure, the second format divides the original image into a plurality of blocks each including pixels, the number of which is a natural number of times greater than n, and allocates the pixels, the number of which is the natural number of times greater than n, to the first to n-th channels, and, in the case where the data structure includes identification data indicating that the transmission format is the second format, the data structure may be configured to further include block size data indicating the size of one block.

The present data structure may be configured to further include channel data indicating to which of the first to n-th channels the data structure corresponds.

In the present data structure, each of the n images may be configured to include the same number of pixels as an image standard of high definition television broadcasting.

The present image transmitting apparatus is configured to transmit content data indicating content of an original image and identification data indicating whether a transmission format is a first or second format, the first format being a format that divides the original image into n areas (n is an integer greater than or equal to 2) and transmits the n area images on first to n-th channels, and the second format being a format that divides the original image into n images (n is an integer greater than or equal to 2) with definition lower than the original image and transmits the n images on first to n-th channels.

The present image transmitting apparatus may be configured to use a differential transmission path for each of the first to n-th channels.

The present image receiving apparatus is configured to accept image data with the above-described data structure.

The present image receiving apparatus may also be configured to sort the content data in accordance with the transmission format indicated in the identification data.

The present display apparatus includes the above-described image receiving apparatus.

The present image transmitting method transmits content data indicating content of an original image and identification data indicating whether a transmission format is a first or second format, the first format being a format that divides the original image into n areas (n is an integer greater than or equal to 2) and transmits the n area images on first to n-th channels, and the second format being a format that divides the original image into n images (n is an integer greater than or equal to 2) with definition lower than the original image and transmits the n images on first to n-th channels.

The present recording medium is a computer-readable medium on which image data with the above-described data structure is recorded.

The present invention is not limited to the above-described embodiments, and the embodiments of the present invention encompass configurations obtained by appropriately modifying or combining the above-described embodiments on the basis of general technical knowledge.

### INDUSTRIAL APPLICABILITY

The present invention is suitable for, for example, an ultra high definition liquid crystal display.

### REFERENCE SIGNS LIST

DSA display apparatus

DP display device

DDA1 to DDA4 divided display areas (in display panel)

ITA image transmitting apparatus

IRA image receiving apparatus

IAC identification data appending circuit

IRC identification data reading circuit

PMC pixel mapping circuit

TC1 to TC8 timing controllers

DC1 to DC4 display control substrates

LCP liquid crystal panel

Pa to Pd pixels

Ga to Gd scanning signal lines

Sa to Sd data signal lines

AR1 to AR8 divided display areas (in liquid crystal panel)

1. A data structure comprising content data indicating content of an original image and identification data indicating whether a transmission format is a first or second format,
the first format being a format that divides the original image into n areas (n is an integer greater than or equal to 2) and transmits the n area images on first to n-th channels, and the second format being a format that divides the original image into n images (n is an integer greater than or equal to 2) with definition lower than the original image and transmits the n images on first to n-th channels.

2. The data structure according to claim 1, wherein the identification data is one piece of auxiliary data.

3. The data structure according to claim 1, wherein the second format divides the original image into a plurality of blocks each including pixels, the number of which is a natural number of times greater than n, and allocates the pixels, the number of which is the natural number of times greater than n, to the first to n-th channels, and,
in the case where the data structure comprises identification data indicating that the transmission format is the second format, the data structure further comprises block size data indicating the size of one block.

4. The data structure according to claim 1, wherein the data structure further comprises channel data indicating to which of the first to n-th channels the data structure corresponds.

5. The data structure according to claim 1, wherein each of the n images includes the same number of pixels as an image standard of high definition television broadcasting.

6. An image transmitting apparatus that transmits content data indicating content of an original image and identification data indicating whether a transmission format is a first or second format,
the first format being a format that divides the original image into n areas (n is an integer greater than or equal to 2) and transmits the n area images on first to n-th channels, and the second format being a format that divides the original image into n images (n is an integer greater than or equal to 2) with definition lower than the original image and transmits the n images on first to n-th channels.

7. The image transmitting apparatus according to claim 6, wherein a differential transmission path is used for each of the first to n-th channels.

8. An image receiving apparatus that accepts image data with the data structure according to claim 1.

9. The image receiving apparatus according to claim 8, wherein the image receiving apparatus sorts the content data in accordance with the transmission format indicated in the identification data.

10. A display apparatus comprising the image receiving apparatus according to claim 8.

11. An image transmitting method of transmitting content data indicating content of an original image and identification data indicating whether a transmission format is a first or second format,
the first format being a format that divides the original image into n areas (n is an integer greater than or equal to 2) and transmits the n area images on first to n-th channels, and the second format being a format that divides the original image into n images (n is an integer greater than or equal to 2) with definition lower than the original image and transmits the n images on first to n-th channels.

12. A computer-readable recording medium on which image data with the data structure according to claim 1 is recorded.
